(19) United States
(12) Patent Application Publication
(10) Pub. No.: US 2014/0023315 A1
(43) Pub. Date: Jan. 23, 2014

(54) Optical Module and a Mounting Structure Thereof

(71) Applicants: Toshiaki Takai, Yokohama (JP); Norio Chujo, Tokyo (JP); Saori Hamamura, Kawasaki (JP)

(72) Inventors: Toshiaki Takai, Yokohama (JP); Norio Chujo, Tokyo (JP); Saori Hamamura, Kawasaki (JP)

(73) Assignee: Hitachi Ltd, Chiyoda-ku Tokyo (JP)

(21) Appl. No.: 13/989,966

(22) PCT Filed: Nov. 18, 2011
(86) PCT No.: PCT/JP2011/006418

§ 371 Date: Sep. 17, 2013

(30) Foreign Application Priority Data
Nov. 29, 2010 (JP) 2010-264489
Oct. 26, 2011 (JP) 2011-234585

(51) Int. Cl. G02B 6/42

(52) U.S. Cl. CPC G02B 6/42
USPC 385/14

(57) ABSTRACT

An optical module achieving optical coupling at a low cost and by a simple and convenient process is intended to be provided. For attaining the purpose, a transparent member sealing an optical device and an optical transmission channel are connected as an optical coupling structure. Specifically, optical coupling is achieved in an optical module having an optical device, a first substrate having the optical device mounted thereon, and a second substrate or a transparent resin provided over the first substrate so as to hermetically seal the optical device by connecting an optical transmission channel over the second substrate or the transparent resin at a portion in which light from the optical device is transmitted.

This application is a national stage of PCT International Application No. PCT/JP2011/006418, filed Nov. 18, 2011, which claims priority under 35 U.S.C. §119 to Japanese Patent Application Nos. 2010-264489, filed Nov. 29, 2010, and 2011-234585, filed Oct. 26, 2011, the entire disclosures of which are herein expressly incorporated by reference.

### TECHNICAL FIELD

The present invention relates to an optical module and an optical coupling process.

### BACKGROUND

One of most important factors in optical modules includes optical coupling between an optical device such as a semiconductor laser or a photodiode and an optical transmission channel such as an optical fiber or an optical waveguide channel. For attaining a high optical coupling efficiency, an accuracy of several tens μm is required in multi-mode transmission and that of several μm is required in single mode transmission.

Further, a manufacturing process for the optical module requires a number of steps for alignment between the optical device and the optical transmission channel, which is a bottleneck in cost reduction of the optical module. Accordingly, it has been strongly demanded to simplify the alignment process.

As an optical coupling structure for realizing such a high optical coupling efficiency, a structure of enhancing the optical coupling efficiency by utilizing the light condensing effect of a lens has been used generally.

As an example of such optical coupling structure, Japanese Unexamined Patent Application Publication No. 2008-41770 discloses a structure of mounting a surface light receiving/emitting device such as a vertical cavity surface emitting laser (VCSEL) or a surface light receiving photodiode to a transparent substrate by flip-chip bonding and disposing a lens below the transparent substrate, thereby optically coupling the surface light receiving/emitting device and the optical transmission channel below the transparent substrate by way of the lens.

### SUMMARY

However, the existent art described above causes a problem in view of the cost.

For example, in Japanese Unexamined Patent Application Publication No. 2008-41770, positioning accuracy between the optical device and the optical transmission channel is determined depending on the accuracy of mounting the flip-chip bonding. Accordingly, for improving the accuracy of mounting the optical device, an expensive highly accurate flip-chip bonding apparatus is necessary. Further, since the optical device and the optical transmission channel are optically coupled by way of the lens, an accuracy for mounting the lens is also required. In an optical system comprising such optical device-lens-optical transmission channel, active alignment has generally been adopted for obtaining a high optical coupling efficiency. However, the active alignment involves a problem that it is not desired with a view point of simplifying the process.

The present invention has been achieved in view of the foregoing problems and it intends to realize optical coupling at a high efficiency by a simple and convenient process and at a reduced cost.

For addressing the problems described above according to the present invention, a sealing structure and an optical transmission channel are welded as an optical coupling structure.

Specifically, in an optical module comprising an optical device, a first substrate having the optical device mounted thereon, and a second substrate or a transparent resin provided over the first substrate so as to hermetically seal the optical device, optical coupling is achieved by connecting an optical transmission channel over the second substrate or the transparent resin at a portion in which light from the optical device is transmitted.

The present invention can provide an optical module that can be manufactured at a reduced cost and by a simple and convenient process.

### BRIEF DESCRIPTION OF THE DRAWINGS

FIG. 1 is a view for explaining an optical module in a first embodiment of the invention;

FIG. 2A is a view for explaining a method of manufacturing the optical module in the first embodiment;

FIG. 2B is a view for explaining the method of manufacturing the optical module in the first embodiment;

FIG. 2C is a view for explaining the method of manufacturing the optical module in the first embodiment;

FIG. 2D is a view for explaining the method of manufacturing the optical module in the first embodiment;

FIG. 2E is a view for explaining the method of manufacturing the optical module in the first embodiment;

FIG. 2F is a view for explaining the method of manufacturing the optical module in the first embodiment;

FIG. 3 is a view for explaining a welding of a sealed wafer and an optical transmission channel in the first embodiment;

FIG. 4A is a view for explaining a mounting structure in which the optical module is applied in the first embodiment;

FIG. 4B is a view for explaining the mounting structure in which the optical module is applied in the first embodiment;

FIG. 5 is a view for explaining a welding configuration between a sealing wafer and an optical transmission channel in a second embodiment;

FIG. 6A is a view for explaining a welding configuration between a sealing wafer and an optical transmission channel in a third embodiment;

FIG. 6B is a view for explaining the welding configuration between a sealing wafer and an optical transmission channel in a third embodiment;

FIG. 7A is a view for explaining a configuration of welding between a sealing wafer and an optical transmission channel in a fourth embodiment;

FIG. 7B is a view for explaining the configuration welding between the sealing wafer and an optical transmission channel in the fourth embodiment;

FIG. 8 is a view for explaining an optical module of a fifth embodiment;

FIG. 9A is a cross sectional view for explaining a method of manufacturing the optical module of the fifth embodiment;

FIG. 9B is a cross sectional view for explaining the method of manufacturing the optical module of the fifth embodiment;

FIG. 10A is a view for explaining a mounting structure in which the optical module is applied in a fifth embodiment;

FIG. 10B is a view for explaining the mounting structure in which the optical module is applied in the fifth embodiment; and

FIG. 11 is a view for explaining a mounting structure in which an optical module is applied in a sixth embodiment.

### DETAILED DESCRIPTION

Preferred embodiments of the present invention are to be described with reference to the drawings. Substantially identical portions carry the same reference numerals, for which description is not repeated.

### First Embodiment

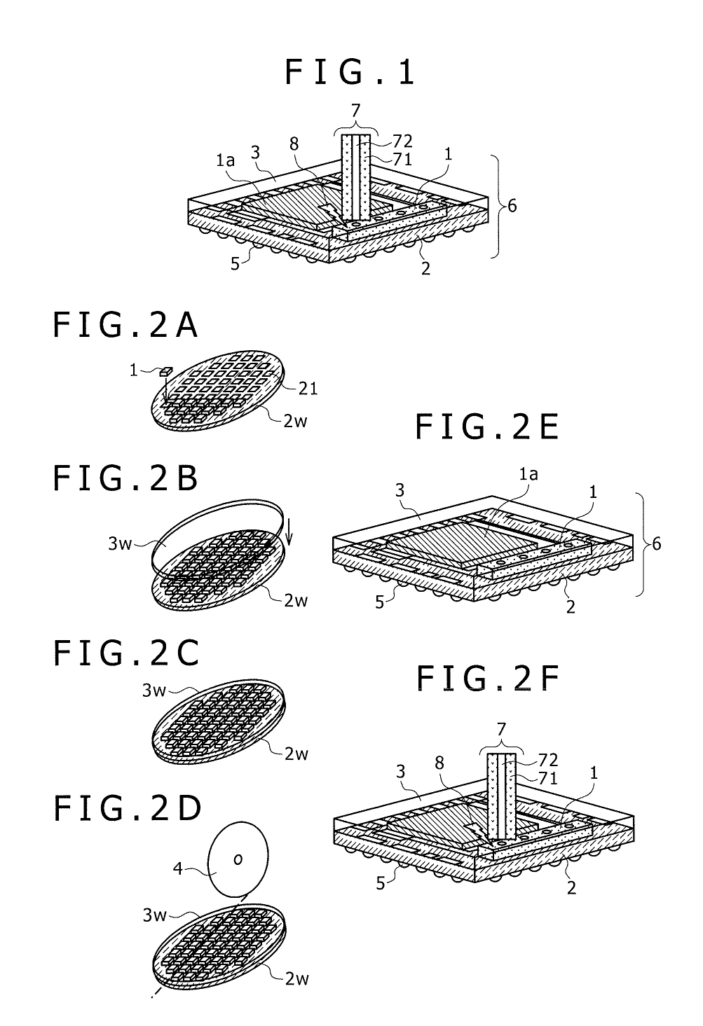

First, the first embodiment of the present invention is to be described with reference to FIG. 1 to FIG. 4B.

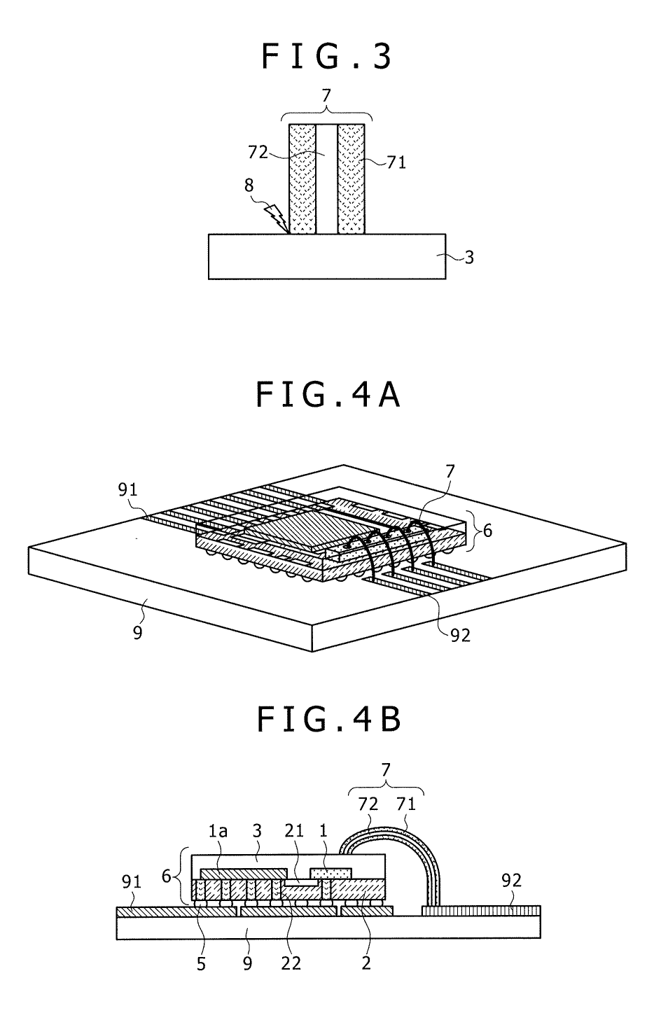

FIG. 1 is a view for explaining a configuration of optical coupling in the first embodiment. FIG. 2 is a cross sectional view for explaining an optical coupling process in the first embodiment. FIG. 3 is a view for explaining welding between a sealing substrate (second substrate) and an optical transmission channel.

FIGS. 4A and 4B are views for explaining an optical module in which the configuration of optical coupling is applied in the first embodiment. Persons skilled in the art can read easily that, in FIG. 4B, the upper surface and the lower surface of a substrate are not present at an identical cross section but are shown as developed cross sectional views. This is also identical in the following embodiments.

First, a light coupling configuration in the first embodiment is to be described with reference to FIG. 1. In the first embodiment, use of an optical module 6 put to wafer level packaging (WLP) by a first wafer substrate 2w and a second wafer substrate 3w is considered. The first substrate 2 is a Si wafer (heat expansion coefficient: 3.3 ppm/K) used most frequently as a substrate for semiconductor devices. A glass material can be used for the second substrate 3 and a transparent amorphous glass material (thermal expansion coefficient: 3.3 to 8.0 ppm/K) is used in this embodiment considering application to an optical device). Generally, borate type glass is used as the material for the second substrate 3 considering bonding with the Si wafer. This is because the thermal expansion coefficient of the borate type glass is approximate to that of Si and there is no problem of warp in the substrate caused by the difference of the thermal expansion coefficient. However, use of the amorphous glass material of excellent optical property for the second substrate 3 is preferred when importance is attached to the optical properties such as refractive index and transmittance.

A vertical cavity surface emitting laser (VCSEL) as an optical device 1 and a driver IC as a LSI 1a which is a driving element that drives the optical device 1 are incorporated into the optical module 6 put to the WLP. Optical signals outputted from the optical device 1 are transmitted through the second substrate 3 and emitted from the optical module 6, and the optical module 6 serves as a sending optical module. The optical device 1 may also be a surface light receiving photodiode in which a trance impedance amplifier (TIA) is used as the LSI 1a and the optical module 6 serves as a receiving optical module.

In this embodiment, a plastic optical fiber (POF) is welded as an optical transmission channel 7 on the second substrate 3 at a portion where optical signals from the optical device 1 are transmitted. Thus, the optical signals emitted from the optical device 1 are introduced into the core layer of the POF and propagated in the POL.

The first substrate 2 is not necessarily restricted to Si but may also be other semiconductor wafers formed of InP, GaAs, SiC, SiGe, GaN, etc. Naturally, the first substrate 2 is not restricted to the semiconductor material but it may comprise other materials such as a glass material, a ceramic material, and a metal material.

Also the second substrate 3 is not restricted to the glass material and may be formed of other materials such as a semiconductor material so long as the substrate allows a light at a wavelength emitted from or incident to the optical device 1 to transmit therethrough.

Further, also the optical transmission channel 7 is not restricted to the POF but may also be an organic optical waveguide.

Then, a specific optical coupling process in the first embodiment is to be described with reference to FIG. 2.

First, in FIG. 2A, the optical device 1 and the LSI 1a are mounted over an electrode pattern 21 of a first wafer substrate 2w. An Au—Sn vapor deposition solder is previously formed as a bonding member over the electrode pattern 21. When a solder material such as a vapor deposition solder is used as the bonding material, metallization is formed over the electrode pattern 21 for ensuring solder wettability. The configuration of the metallized metal has a stacked plating structure comprising 2 to 5 μm Ni and 0.05 μm Au. Generally, when bonding is performed by a solder material, an inter-metallic compound is formed at the boundary between the solder material and Au after bonding. Since the inter-metallic compound is rigid and weak in the stress damping effect, it deteriorates the reliability of bonding against impact or the like. Further, if Au remains, the inter-metallic compound grows further by being left at high temperature subsequently to cause Kirkendall voids and bring about a worry of deterioration in the reliability and the hermetic seal. Therefore, it is preferred to reduce the thickness of Au plating as much as possible. In this embodiment, the thickness of Au plating is 0.05 μm.

For avoiding the complexity of the drawing, LSI 1a, vapor deposited solder, and metallized metal are not illustrated in FIG. 2.

Then, in FIG. 2B and FIG. 2C, after wafer alignment of the first wafer substrate 2w and the second wafer substrate 3w, the first wafer substrate 2w and the second wafer substrate 3w are bonded by anodic bonding to hermetically seal the optical device 1 and the LSI 1a. As described above, the mounting cost can be decreased, and the characteristics of the optical device 1 can be ensured to improve the reliability by hermetic seal in the state of the wafer.

The anodic bonding is to be described specifically. Generally, the anodic bonding is a technique of superposing a glass substrate to a Si wafer, pressing electrodes to the lower surface of the Si wafer and the upper surface of the glass substrate, and bonding them by applying a voltage to Si as an anode and to the glass as a cathode while heating the entire portion to about 400° C. Alkali ingredients such as Na contained in the glass tend to be diffused by heating. When the voltage is applied in this state on the anode of Si and the cathode of glass, such alkali ingredients are ionized and diffused. It is said that the cations of Na are attracted to the upper surface of the glass substrate, that is, to the cathode and a cation depleted layer is formed near the bonding boundary with the Si wafer. It is considered that the region is originally neutral in view of electric charges but positive electric charges are decreased by compulsory diffusion of the cations due to the voltage and the region is negatively charged relatively. The charging generates further intense electrostatic attraction with respect to the Si wafer, and firmly bonds the Si wafer and the glass substrate. At the same time, a firm bonding is formed at the boundary between Si and glass by oxidation of Si with oxygen.

An advantage obtained by the application of the anodic bonding to the sealing is that hermetic seal can be achieved at a low cost since glass is directly bonded to the Si substrate and, accordingly, no additional cost is caused.

In this embodiment, since Si is used as the first wafer substrate 2w, anodic bonding is adopted as a method of bonding the first wafer substrate 2w and the second wafer substrate 3w, but this is not restrictive and they may be bonded also by means of a solder material, adhesive, etc.

Then, in FIG. 2D, the bonded wafers are cut into individual optical modules 6 in the form of wafer level packaging by wafer dicing using a dicing blade 4. Solder bumps of Sn-3Ag-0.5Cu are formed as solder bumps 5 at the rear face of the optical module 6 for ensuring electric conduction as shown in FIG. 2E. Thus the individualized optical module 6 can be handled as a chip. The optical module 6 formed with the solder bumps 5 is bonded by way of the bumps 5, for example, to an organic substrate formed with electric wirings.

Then, an optical transmission channel 7 is bonded to the second substrate 3 as shown in FIG. 2F. In this embodiment, a plastic fiber (POF) is used as the optical transmission channel 7. For bonding the optical transmission channel 7 and the second substrate 3, the optical transmission channel 7 is positioned to a portion of the second substrate 3 where optical signals from the optical device 1 transmit and then the clad layer 71 of the POF and the glass material of the second substrate 3 are welded by a laser light to fix the optical transmission channel 7 to the second substrate 3 as illustrated in FIG. 3. In this embodiment, the POF is used as the optical transmission channel 7 which provides the following advantage. Since the core layer 72 of the POF generally has a size of 125 μm φ which is larger than that of a single mode fiber, required positioning accuracy for the POF is moderated and the POF can be fixed easily by the laser welding, the alignment step can be simplified.

In this embodiment, laser welding is used as a method of fixing the optical transmission channel 7 to the second substrate 3 but this is not always accessory and a method such as adhesion may also be used so long as the optical transmission channel 7 is fixed to the second substrate 3.

Application of the optical coupling structure in this embodiment to optical wirings is to be described with reference to FIG. 4. In this embodiment, an optical module 6 in the form of the WLP is mounted over an optical and electrical hybridization substrate 9 as in semiconductor devices in existent electronic equipment. Electric wirings 91 for transmitting electric signals and optical wirings 92 for transmitting optical signals are formed over the optical and electrical hybridization substrate. The optical module 6 and the optical and electrical hybridization substrate 9 ensure electric conduction between the optical module 6 and the optical and electrical hybridization substrate 9 by connection, for example, by means of a Pb-free solder. The bonding material for the optical module 6 and the optical and electrical hybridization substrate 9 is not restricted to the solder but other materials, for example, electroconductive adhesive may also be used so long as the electric conduction can be ensured.

The POF is welded to the optical module 6 mounted over the optical and electrical hybridization substrate 9 by laser welding as in the step illustrated in FIG. 2E. In the same manner, the top end of the POF on the side opposite to the side where it is welded with the second substrate 3 is fixed to the optical wirings 92 over the optical and electrical hybridization substrate 9 by laser welding.

Electric signals transmitted from the electric wirings 91 over the optical and electrical hybridization substrate 9 are transmitted to the LSI 1a by way of through vias 22 formed in the first substrate. The LSI 1a generates signals corresponding to the transmitted electric signals which drive the optical device 1 and are converted into optical signals. The converted optical signals are guided by way of the second substrate 3 to the core layer 72 of the optical transmission channel 7. The introduced optical signals are further propagated in the core layer 72 and the optical signals are transmitted in the optical wirings 92 over the optical and electrical hybridization substrate 9.

As described above according to the optical coupling structure described for this embodiment, the optical module 6 in the form of the WLP can be handled as a chip and the optical module 6 can be handled in the same manner as that for the semiconductor device in existent electronic equipment. Further, since the required positioning accuracy is moderated and the optical transmission channel 7 can be fixed easily by laser welding by using the POF of a large core diameter as the optical transmission channel 7, the aligning step can be simplified.

### Second Embodiment

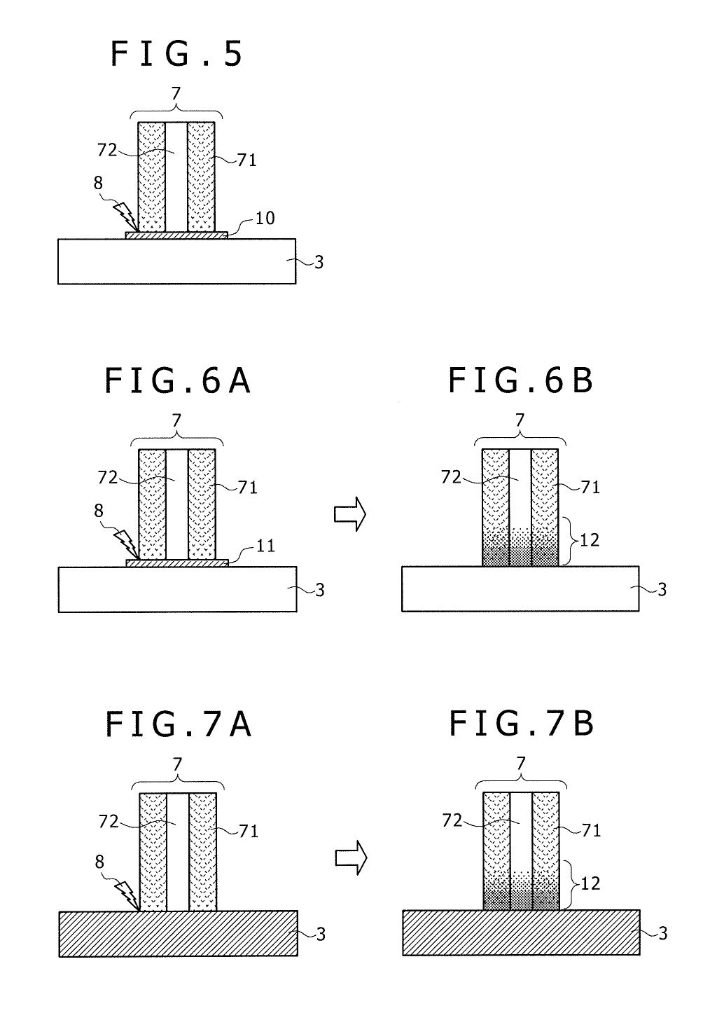

A second embodiment of the present invention is to be described with reference to FIG. 5. In this embodiment, a bonding method between the second substrate 3 and the optical transmission channel 7 in the first embodiment is changed but other structures and the processes are identical with those of the first embodiment.

In this embodiment, a laser light absorption resin 10 that absorbs a laser light at a wavelength utilized for laser welding is supplied previously to the second substrate 3 at a portion where the optical transmission channel 7 is bonded. Thus, the laser light upon irradiation is absorbed in the laser light absorption resin 10 upon laser welding and the laser light absorption resin generates heat. By the generation of heat, temperature of the laser welded portion increases and improvement in the bonding strength between the second substrate 3 and the optical transmission channel 7 can be expected.

The laser light absorption resin 10 supplied over the second substrate 3 is supplied preferably in an extremely thin state. When the laser light absorption resin is present between the second substrate 3 and the optical transmission channel 7, optical signals emitted from the second substrate 3 are absorbed and scattered by the laser light absorption resin 10 and, as a result, the intensity of the optical signals propagated in the optical transmission channel 7 may possibly be lowered. Then, in this embodiment, the thickness of supplying the resin is made 10 μm or less by supplying the laser light absorption resin 10 to the second substrate 3 by spin coating.

Preferably, the refractive index of the laser light absorption resin is substantially equal with that of the second substrate 3 or the core layer 72 of the optical transmission channel 7. Since the laser light absorption resin 10 is present between the second substrate 3 and the optical transmission channel 7, when the difference of refractive index is present between the boundaries of the laser light absorption resin 10, a Fresnel reflection loss due to the difference of the refractive index may be caused at the boundaries. In order to decrease the Fresnel reflection loss, the refractive index of the laser light absorption resin 10 is substantially made equal with the refractive index of the glass of the second substrate 3.

As described above, according to the optical coupling structure described in this embodiment, since the temperature at the laser welded portion increases, bonding strength between the second substrate 3 and the optical transmission channel 7 can be improved.

### Third Embodiment

A third embodiment of the present invention is to be described with reference to FIG. 6. Also in this embodiment, the bonding method between the second substrate 3 and the optical transmission channel 7 in the first embodiment is changed but other structures and the processes are identical with those of the first embodiment.

In this embodiment, a transparent resin 11 is previously supplied to a second substrate 3 at a portion where an optical transmission channel 7 is to be bonded. For the transparent resin 11, a resin having a refractive index higher than that of a core layer 72 of an optical transmission channel 7 is used. Upon laser welding, the glass of a second substrate 3 and the optical transmission channel 7 are melted by laser light irradiation, in which the transparent resin 11 is diffused into the optical transmission channel 7. Thus, a diffusion layer 12 of the transparent resin 11 is formed in the optical transmission channel 7. A distribution of refractive index is formed in the diffusion layer 12 such that the refractive index on the side of the boundary with the second substrate 3 is higher than the refractive index on the side remote from the boundary. When such a distribution of refractive index is present in the core layer 72 of the optical transmission channel 7, the same effect as a Grin (Graded Index) lens is formed in the diffusion layer 12. In other words, optical signals emitted from the second substrate 3 are converged in the diffusion layer 12, and as a result, improvement in the intensity of the optical signals propagating in the optical transmission channel 7 can be expected.

Also in this embodiment, the thickness of the supplied resin is defined as 10 μm or less by supplying the transparent resin 11 to the second substrate 3 by spin coating. The method of supplying the transparent resin 11 is not restricted to the spin coating so long as an amount capable of forming the diffusion layer 12 can be supplied.

As described above, according to the optical coupling structure described in this embodiment, distribution of the refractive index is caused in the optical transmission channel 7, and this provides the Grin lens effect, and can improve the intensity of the optical signals propagating in the optical transmission channel 7.

### Fourth Embodiment

A third embodiment of the present invention is to be described with reference to FIG. 7. Also in this embodiment, the bonding method between the second substrate 3 and the optical transmission channel 7 in the first embodiment is changed but other structures and the processes are identical with those of the first embodiment.

In this embodiment, a glass material having a refractive index higher than the refractive index of the core layer 72 of the optical transmission channel 7 is used for the second substrate 3. Thus, upon laser welding, the glass material of the second substrate 3 and the optical transmission channel 7 are melted by the laser light irradiation in the same manner as in the third embodiment. In this case, the glass material of the second substrate 3 diffuses into the optical transmission channel 7. Thus, a diffusion layer 12 of the glass material of the second substrate 3 is formed in the optical transmission channel 7. As a result, a distribution of refractive index is formed in the diffusion layer 12 such that the refractive index on the side of the boundary at the second substrate 3 is higher and the Grin lens effect is generated as in the third embodiment.

As described above, also in this embodiment, distribution of refractive index is caused in the optical transmission channel 7, and this provides the Grin lens effect, and the intensity of the optical signals propagated in the optical transmission channel 7 can be improved.

### Fifth Embodiment

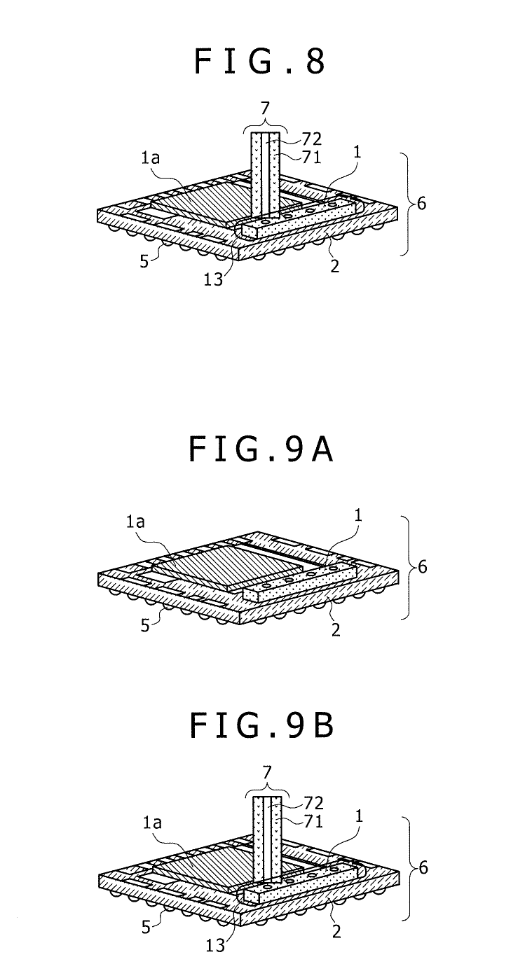

A fifth embodiment of the present invention is to be described with reference to FIG. 8 to FIG. 10.

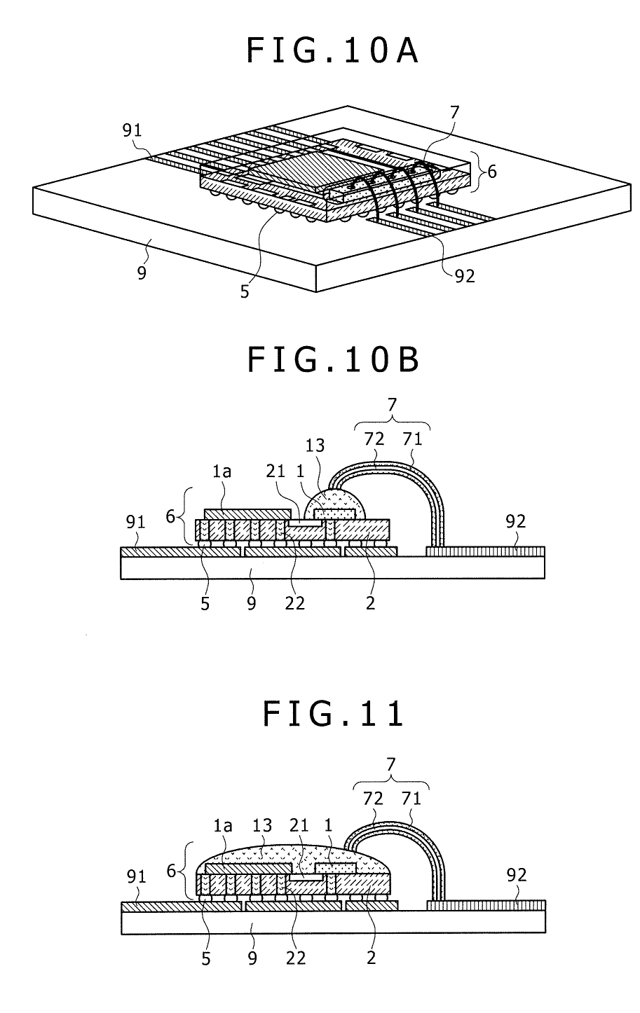

FIG. 8 is a view for explaining a configuration of optical coupling in the fifth embodiment. FIG. 9 is a cross sectional view for explaining an optical coupling process in the fifth embodiment. FIG. 10 is a view for explaining an optical module in which the configuration of the optical coupling in the fifth embodiment is applied.

First, the optical coupling configuration in the fifth embodiment is to be described with reference to FIG. 8.

The fifth embodiment is identical with the first embodiment in that a first wafer substrate 2, an optical device 1, a LSI 1a, an optical transmission channel 7, and solder bumps 5 are provided and detailed description for the structures and the processes thereof are omitted. The fifth embodiment is different from the first embodiment in that the second wafer substrate is not provided and a transparent resin 13 is provided at the periphery of the optical device 1. The transparent resin 13 covers the optical device 1 and is connected with the optical transmission channel 7. Optical signals emitted from the optical device 1 are guided by way of the transparent resin 13 to the core layer of the optical transmission channel 13 and propagated therein.

Next, a specific optical coupling process in the fifth embodiment is to be described with reference to FIG. 9.

First, in the same process as in the first embodiment, an optical device 1 and a LSI 1a are disposed over a first wafer 2 and solder bumps 5 are disposed therebelow as illustrated in FIG. 9A. Different from the first embodiment, this embodiment has no second wafer and lacks in the process of bonding the second wafer and the first wafer 2.

Then, an optical transmission channel 7 is bonded to the optical device 1 as illustrated in FIG. 9B. In this embodiment, a plastic fiber (POF) is used as the optical transmission channel 7. First, a transparent resin 13 is coated and cured over the optical device 1. In this step, the transparent resin 13 covers the entire optical device 1 and hermetically seals the optical device 1. Then, for the optical transmission channel 7 and the optical device 1, the POF is positioned at a portion where the optical signals from the optical device 1 transmit therethrough, and then the transparent resin 13 and the POF are welded by a laser light.

In this embodiment, while a UV-curable resin is preferred as the transparent resin 13, a thermosetting resin may also be used.

The method of fixing the optical transmission channel 7 is not restricted to the laser welding. The operation time can be decreased remarkably, for example, by using a UV-curable resin, positioning the optical transmission channel 7 and the optical device 1 after coating and before curing the UV-curable transparent resin 13, curing the transparent resin 13 by UV light irradiation, and adhering to fix the optical transmission channel 7 by the transparent resin 13.

Also in this embodiment, the POF is used as the optical transmission channel 7. This is advantageous since the diameter of the core layer 72 of the POF is generally large as 125 μm φ which is larger than that of the single mode fiber and, accordingly, required accuracy for positioning the POF is moderated and the bondability with the transparent resin 13 is satisfactory.

In this embodiment, while the UV curable resin is used as the method of fixing the optical transmission channel 7, this is not always necessary but other transparent resin such as a thermosetting resin may also be used so long as the optical transmission channel 7 is fixed. Further, when the optical transmission channel is connected by laser welding, the second embodiment of the invention may also be combined such that configuration of the laser light absorption resin may be disposed between the transparent resin 13 and the optical transmission channel 7 and welded by laser light. Further, the transparent resin 13 may be diffused into the optical transmission channel 7 upon laser welding as in the third embodiment. While coating and curing of the transparent resin 13 and the connection of the optical transmission channel 7 are performed in the state where the wafer is cut into individual chips, the processing up to the coating and curing of the transparent resin 13 and, further, connection of the optical transmission channel 7 may be performed also in the state of the wafer before it is cut into individual chips.

Then, a configuration of applying the optical coupling structure of this embodiment to optical wirings is to be described with reference to FIGS. 10A and 10B. FIG. 10A is a perspective view of an optical module mounting structure according to this embodiment and FIG. 10B is a cross sectional view thereof. Description for the configurations of this embodiment in common with those of the first embodiment illustrated in FIG. 4 is to be omitted. In this embodiment, an individualized optical module 6 is mounted over the optical and electrical hybridization substrate 9 as in semiconductors device in existent electronic equipment. As illustrated in FIG. 9B, the POF is welded by a transparent resin 13 to the optical module 6 mounted over the optical and electrical hybridization substrate 9. In the same manner, the top end of the POF on the side opposite to the side adhered with the optical device 1 is fixed to the optical wirings 92 over the optical and electrical hybridization substrate 9.

Electric signals transmitted from electric wirings 91 over the optical and electrical hybridization substrate 9 are transmitted by way of through vias 22 formed in the first wafer substrate to the LSI 1a. The LSI 1a generates signals corresponding to the transmitted electric signals, which drive the optical device 1 and are converted into optical signals. The converted optical signals are guided by way of the transparent resin 13 to the core layer 72 of the optical transmission channel 7. Further, the guided optical signals are propagated in the core layer 72 and the optical signals are transmitted in the optical wirings 92 of the optical and electrical hybridization substrate 9.

As described above according to the optical coupling structure described for this embodiment, the optical module 6 in the form of the WLP can be handled as a chip and the optical module 6 can be handled in the same manner as that for the semiconductor device in the existent electronic equipment. Further, since the required positioning accuracy is moderated by using the POF of a large core diameter as the optical transmission channel 7 and the optical transmission channel 7 can be fixed easily by the transparent resin, the alignment step can be simplified.

### Sixth Embodiment

A sixth embodiment according to the present invention is to be described with reference to FIG. 11. Also in this embodiment, an optical transmission channel 7 is bonded by a transparent resin 14 in the same manner as in the fifth embodiment and structures and processes are identical with those of the fifth embodiment.

In this embodiment, after cutting the wafer into individual optical modules 6 by dicing, the entire optical module including not only the optical device 1 but also the LSI 1a is hermetically sealed by a transparent resin 13. This can prevent intrusion of obstacles in the optical channel of the optical module 6. Further, moisture proofness can also be improved.

Alternatively, optical devices 1 and LSIs 1a of a plurality of optical modules may be sealed by a lump of the transparent resin in the state of a wafer before cutting into individual chips and they may be cut into individual chips together with transparent resin by dicing.

As described above, in this embodiment, reliability can be improved by resin encapsulation of the optical device.

What is claimed is:

1. An optical module comprising:
an optical device;
a first substrate having the optical device mounted thereon; and
a second substrate bonded to the first substrate so as to hermetically seal the optical device,
wherein an optical transmission channel is bonded over the second substrate so as to be in optical coupling with the optical device.

2. The optical module according to claim 1,
wherein the first substrate comprises a semiconductor and the second substrate comprises a glass or plastic.

3. The optical module according to claim 1,
wherein the second substrate comprises a glass and the first substrate and the second substrate are anodically bonded.

4. An optical module comprising:
an optical device; and
a first substrate having the optical device mounted thereon,
wherein a transparent resin for hermetically sealing the optical device is provided, and
wherein an optical transmission channel is connected over the transparent resin so as to be in optical coupling with the optical device.

5. The optical module according to claim 4,
wherein a semiconductor device mounted over the first substrate and driving the optical device is provided, and
wherein the transparent resin hermetically seals the optical device and the semiconductor device.

6. The optical module according to claim 1,
wherein the first substrate has electric wirings, and
wherein the optical device is electrically connected with the electric wirings of the first substrate.

7. The optical module according to claim 1,
wherein the optical transmission channel is bonded to the second substrate or the transparent resin by laser welding.

8. The optical module according to claim 1,
wherein the optical transmission channel is bonded to the second substrate by means of an adhesive.

9. The optical module according to claim 4,
wherein the transparent resin serves as an adhesive by which the optical transmission channel is adhered.

10. The optical module according to claim 1,
wherein a resin is formed between the second substrate and the optical transmission channel.

11. The optical module according to claim 7,
wherein the refractive index of the second substrate is higher than the refractive index of the optical transmission channel.

12. The optical module according to claim 10,
wherein the resin absorbs a laser light.

13. The optical module according to claim 10,
wherein the refractive index of the resin is higher than the refractive index of the optical transmission channel.

14. The optical module according to claim 1,
wherein a refractive index of the optical transmission channel on the side of the boundary with the second substrate or the transparent resin is higher than the refractive index on the side remote from the boundary.

15. The optical module according to claim 14,
wherein the refractive index of the optical transmission channel is made higher by the diffusion of the second substrate, the resin, or the transparent resin into the optical transmission channel.

16. A mounting structure of an optical module comprising:
the optical module according to claim 1; and
a third substrate having the optical module mounted thereon and having electric wirings and an optical channel,
wherein the optical device is electrically connected by way of the first substrate to electric wirings over the third substrate, and coupled optically by way of the optical transmission channel to the optical channel over the third substrate.
